(19) United States
(12) Patent Application Publication
(10) Pub. No.: US 2007/0038425 A1
(43) Pub. Date: Feb. 15, 2007

(54) Hybrid simulation system and method of simulating systems

(76) Inventors: Chunsheng Fu, West Chester, OH (US); Michael Joseph Creed, Liberty Township, OH (US); Robert Joseph Aleksa, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/190,417

(22) Filed: Jul. 27, 2005

(51) Int. Cl. G06F 17/50; G06F 19/00

(52) U.S. Cl. 703/13; 700/95

(57) ABSTRACT

A virtual processor usable in a simulation system. The virtual processor may receive input from a process controller. The process controller provides control signals to the virtual processor. The virtual processor, in turn, provides process signals to one or more field instruments, eliminating the need to simulate those field instruments, by keeping the instrument(s) as part of the simulation system. The output of the field instruments may then be routed back to the process controller in a feedback loop, or simply used to determine the response of the system.

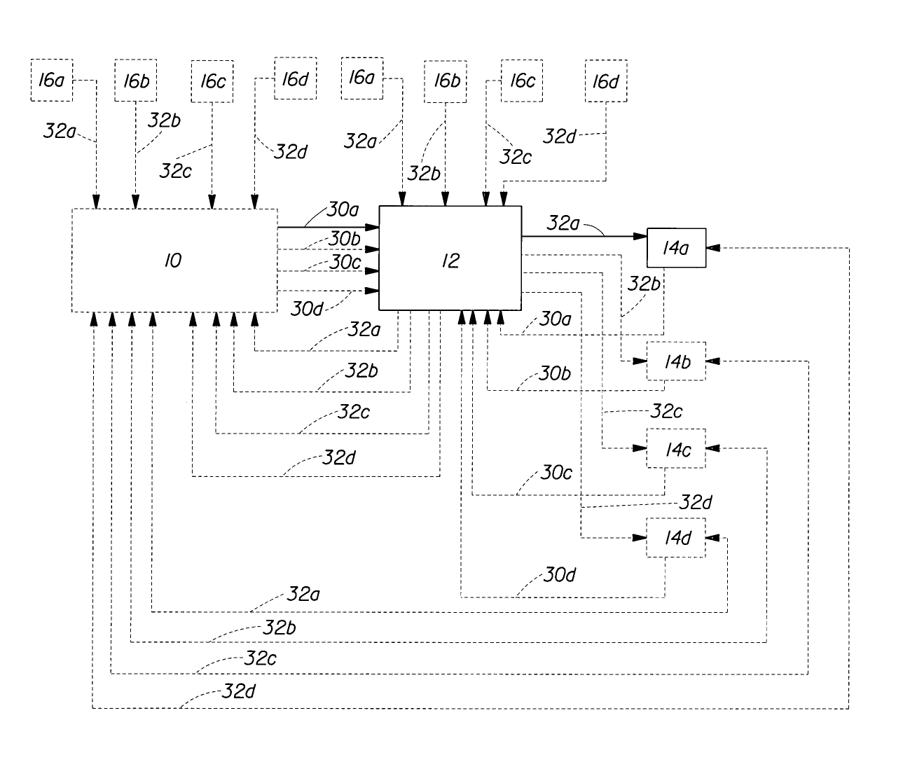

### FIELD OF THE INVENTION

The invention relates to control system simulation.

### BACKGROUND OF THE INVENTION

A typical control system comprises an MES (manufacturing execution system), HMI (human machine interface), a process controller, a PLC (programmable logic controller), field instruments, etc.

The MES may perform production planning and scheduling, recipe transfer and execution management, data archiving and analysis, etc. The HMI is used by the operator to monitor and, if necessary, intervene in a desired process.

HMI user screens may be used to enter functional requirements, inputs and perturbations to the system. This use allows the operators to become familiar with the HMI, and to duplicate simulated operations which are intended to be performed or modeled. The HMI may provide input to a process controller. The HMI provides an indication of the response of the apparatus to changes within the apparatus. Such changes typically originate in a simulation program.

The control system or a component thereof, such as the HMI, may switch between a simulation mode and a field process control mode and may be able to configure one or more simulation parameters. The control system or a component thereof, such as the HMI, may activate a virtual processor in multiple modes, such as a mode usable to acquire calibration data from one or more instruments, a mode usable to generate and/or update simulation parameters, a mode usable to run simulation logic, etc.

The process controller may be used to control one or more batch or continuous processes such as real process logic controls, communication and data transfers between the process controller and the MES and HMI, communication and data transfers between the process controller and external apparatuses, input/output (I/O) mapping, etc.

Field instruments include but are not limited to devices driven as control elements such as actuators, hydraulic activators, valves, lights, positioning systems, motors, heat exchangers, etc. Other types of field instruments may comprise source devices used to obtain/measure digital and analog parameters such as weight, temperature, level, flow rate, pressure, displacement, tension, limit switch operation, the valve position, pH, speed, etc. Some field instruments may have sophisticated functions and features usable to carry out tasks for system identification, control or both. Process equipment usable with the field instruments includes material transfer pipes, tanks, wiring, etc.

Input mapping may be used to obtain status from parameters used in the process. Such parameters may include temperature, flow rate, pressure, displacement, etc. Output mapping may be used to send control signals/data to one or more field instruments.

Large control systems comprising HMI's, MES's, process controllers, machine controllers, PLC's, field instruments, etc., can be expensive to build, and more expensive to rework. Such control system is typically tested to determine whether or not the control system will be adequate to meet the needs and specifications it is intended to fulfill. Major automation projects, such as building new systems, replacing obsolete systems, and expanding existing systems benefit from testing and simulation in order to effectively test new technologies, test and debug new application code, conduct operator training prior to system startup, and train engineers and technicians on new technologies. Specifically, such control systems are often tested for fidelity of response to inputs and to determine whether or not the control system will meet future needs.

Testing of control systems and plant simulations may be accomplished by simulating the input/output devices (I/O) to which the control system is coupled when installed in its operating environment. Traditionally, simulation functionality for the process is built into the industrial process controller and combined with real process control logic. In other embodiments, simulation functionality is built and executed with a simulation application in a computing environment, particularly for high fidelity simulation functions.

Simulation may also be accomplished by simulating the I/O devices with data tables. The data tables comprise software data that provide the expected output for a given input. This allows one to record outputs from the HMI, as generated by the simulation system and to compare the outputs to such expected values. The difference between the outputs and expected values comprise errors which may be used to further refine the system.

However, such a simulation system is subject to inaccuracies. For example, the data table may not always accurately reflect actual operating conditions at a given point in time. Even if the data are accurate at one point in time, environmental factors, equipment, aging and even differences in installation of the same equipment may cause the actual output to vary from those recorded in the data table. These differences present inaccuracies which may be difficult to quantify, or even to know about prior to using the real system.

Furthermore, as a control system becomes larger, having the proper network configuration with all necessary components properly in place, is often helpful for system testing and simulation. But, as systems become larger, accurate simulation may become more difficult to achieve.

Furthermore, some functions and features for process controls may be too complex and difficult to accurately use with simulation code in process controller(s) or simulation computers. For example, certain advanced functions/features built into external apparatuses, such as field instrument, are difficult to duplicate. Such difficulties include lack of data and knowledge about how the functions or features are built, significant memory requirements for simulation purposes when using process controller(s), and difficulty writing modularized code for simulation.

To overcome the limitations of simulation analysis and data tables, attempts have been made to perform system analyses which more accurately measure and forecast system responses. However, to date, none have proven entirely satisfactory.

### SUMMARY OF THE INVENTION

The invention comprises an apparatus for simulating responses to changes in a system. The apparatus comprises a virtual processor. The virtual processor is structured to communicate with at least one field instrument by sending output in the form of process signals to a field instrument. The field instrument may optionally be part of the apparatus.

The invention also comprises a method for predicting responses in the system to changes occurring within the system. The method comprises the steps of providing an output signal in the form of at least one control signal. The output signal is converted to a process signal. The process signal is then provided as input to a field instrument. The field instrument can then receive the process signal as input and respond.

### BRIEF DESCRIPTION OF THE DRAWING

The FIGURE shows a schematic diagram of a system according to the present invention showing optional elements and optional signals in dashed lines.

### DETAILED DESCRIPTION OF THE INVENTION

Referring to the FIGURE, in one embodiment, the invention comprises an apparatus having a virtual processor 12 with output routable to one or more field instruments 14a, 14b, 14c, . . . . The virtual processor 12 may be in communication with a process controller 10 and receive input therefrom. Feedback loops may be incorporated so that the process controller 10 receives input from the virtual processor 12 and/or one or more of the field instruments 14a, 14b, 14c, . . . .

The apparatus and method according to the present invention may be used for testing of a control system, testing of new control technologies, testing of new field instruments 14a, 14b, 14c, . . . , training, etc. System operations may be run in a variety of states including but not limited to normal modes, abnormal modes, emergency modes, transient modes, startup modes, test modes, etc. Examining the invention in more detail, the present system comprises input/output having one or more of three types of simulation signals. The simulation signals may express or represent desired commands, responses, variables, parameters, inputs or outputs within the system and across the boundary separating the system from the external environment. The simulation signals described below are wireless and wired electrical signals although other signals, such as pneumatic signals, hydraulic signals, radio signals, light signals, and other electromagnetic signals and combinations thereof may be utilized and are within the scope of the invention. The electrical simulation signals described herein may be analog or digital signals communicated by modem, Internet, etc.

The first type of simulation signal is a control signal 30a. A control signal 30a represents a command which may originate from an origin within the system and is sent to one or more predetermined components in the system. The command is a directive for such component(s) to perform, partially perform, alter, change or cease performing an operation. Exemplary control signals 30a, 30b, 30c, . . . include, and are not limited to, commands to open/close a valve, partially open/close a valve, start/stop a motor/pump, accelerate/decelerate a motor to a specific rpm or to a specific profile, control a dancer, activate a splicer, follow a cam profile, turn on a heater, or bank of heaters, start/stop a mixer, dump a hopper of batch materials, etc.

The second type of simulation signal is a process signal 32a. A process signal 32a indicates a response, value or parameter within or external to the system indicating an action taken by or state of one or more components. Exemplary process signals 32a, 32b, 32c, . . . include, and are not limited to, flow rate, temperature, weight such as may occur within a batch process, pressure, roll diameter, speed, registration, level, horsepower, error indicating differences between setpoints and actual measured properties, amperage, etc.

A process signal 32a may be considered to be a proportional process signal 32a. A proportional process signal 32a has a value which relates to, and it may correspond to, the parameter indicated within the system. The proportional process signal 32a may be proportionately related to the value within the system in a direct linear function, a second order function, a third order function, discrete function, continuous function, discontinuous function, rule-based function, may be inversely related, etc. Proportional process signals 32a, 32b, 32c, . . . , do not include computer signals which comprise communications from software or data tables, etc., intended to mimic or make software-based predictions of system responses, values, or parameters.

The system may comprise or utilize a third type of simulation signal, such as one or more status signals. A status signal is a qualitative indication that an event has occurred, has not occurred or has ceased to occur in the system. Further information may be provided with the status signal, such as how well a desired command achieved a desired function or result. Exemplary and non-limiting status signals may be an indication that a valve is/has opened/closed, a pump/motor/heater is/is not/has/has not been started/stopped, a setpoint is/is not/has/has not been reached, a limit switch has/has not been tripped, a material dump has/has not occurred, that an error has/has not occurred, abnormal state has/has not occurred, a hardware fault has/has not occurred, etc.

An error is the difference between a setpoint, which is typically but not necessarily predetermined, and a value indicated by a process signal 32a, which is typically but not necessarily a proportional process signal 32a. Thus, a quantitative error status signal may indicate the difference as a percentage or absolute value between the desired response and the simulated or predicted response has occurred.

For example, if the setpoint indicated that 100 kg of batch material were to be added to the process and the process signal 32a indicated that only 98 kg of material were added, an error of 2% or 2 kg may be indicated, and optionally recorded.

The simulation signals may be discrete or analog. Discrete signals, as used herein, are inclusive of but not limited to pulsed outputs and may qualitatively indicate states such as on/off, greater than/less than, etc. Analog signals may quantitatively indicate a value.

Generally, the system will have a plurality of simulation signals, including plural control signals 30a, 30b, 30c, . . . , and plural process signals 32a, 32b, 32c, . . . . There is not necessarily a one-to-one correspondence between the process signals 32a, 32b, 32c, . . . , and control signals 30a, 30b, 30c, . . . . Often, multiple process signals 32a, 32b, 32c, . . . , will be considered and integrated together to determine when, if and certain control signal(s) should be sent to one or more components within the system.

The system may optionally include a process controller 10. Alternatively, the process controller 10 may be external to the system under consideration and may provide simulation signals across the system boundary to the virtual processor 12.

The process controller 10 is able to receive input comprising at least one process signal 32a. The process controller 10 is further able to send one or more outputs comprising a control signal 30a. Such output is routable to the virtual processor 12. Thus, the process controller 10 is structured to receive process signals 32a, 32b, 32c, . . . , from one or more sources and to send one or more control signals 30a, 30b,30c, . . . , to the virtual processor 12. Such input and output comprise one or more simulation signals, particularly process signals 32a, 32b, 32c, . . . , and control signals 30a, 30b, 30c, . . . , respectively. The process signals 32a, 32b, 32c, . . . , which function as input to the process controller 10 may be received from the HMI or other system inputs. Additionally, the process signals 32a, 32b, 32c, . . . , may be received in the form of feedback from other components within the system, such as the virtual processor 12 and/or one or more field instruments 14a, 14b, 14c, . . . .

The process controller 10 and virtual processor 12 may communicate through standard or custom communication protocols, analog current signals, digital signals etc. If desired, communication software may be optionally interposed between the process controller 10 and the virtual processor 12 for data/information exchange. Suitable communication software is available the Modbus Organization of Hopkinton, Mass. as Modbus.

A suitable process controller 10 must be able to receive a number of inputs and provide a number of outputs adequate to simulate the system under consideration. One suitable process controller is a Model No. 1756-L63 PLC made by The Rockwell Automation Company of Milwaukee, Wis.

The virtual processor 12 may be in communication with the optional process controller 10, if present, and receive output from the process controller 10 as input to the virtual processor 12. The virtual processor 12 converts a control signal 30a received from the process controller 10 into a process signal 32a, and optionally into a proportional process signal 32a. The virtual processor 12 may send output in the form of at least one process signal 32a.

Output from the virtual processor 12 is routed to one or more field instruments 14a, 14b, 14c, . . . . Specifically, the virtual processor 12 is structured to route one or more process signals 32a, 32b, 32c, . . . , to one or more field instruments 14a, 14b, 14c, . . . . This arrangement provides the benefit, not known in the prior art, that instrument performance features and functions can be used without simulation. This is beneficial for instruments having responses, performance and functions difficult to accurately model. Accordingly, it is unnecessary to simulate the response of such field instruments 14a, 14b, 14c, . . . . Thus, any error, deviation, or lack of fidelity between the response of the field instrument 14a and the proposed simulation code is eliminated. This provides a more accurate simulation, particularly under dynamic operating conditions. The field instrument 14a may respond to the input provided thereto by starting, stopping, throttling, indicating status and/or otherwise performing one or more functions.

The output from the virtual processor 12 may also be routed as feedback in a feedback loop to the process controller 10 and thereby become input to the process controller 10. The virtual processor 12 may provide either or both discrete output and/or analog output.

While the process controller 10 and the virtual processor 12 are illustrated as separate components, the invention is not so limited. The process controller 10 and the virtual processor 12 may be contained in a single piece of hardware. Additionally, the functions of the process controller 10 and/or the virtual processor 12 may be performed locally or in the vicinity of the system under consideration. Alternatively such functions may be performed remotely by transmission to a mainframe computer, remote personal computer, etc. While a single process controller 10 and virtual processor 12 are illustrated in the FIGURE, the invention is not so limited. Plural process controllers 10 and/or virtual processors 12 may be used and arranged in series and/or in parallel as desired.

Simulation signals from the virtual processor 12 should be compatible with the specific calibration of the field instrument 14a. If desired, a converting circuit may be interposed between the virtual processor 12 and the field instrument 14a. The converting circuit may comprise a resistor network, etc., and converts the process signal 32a taken as output from the virtual processor 12 to a format which is compatible with that particular field instrument 14a. The converting circuit is optional, and used as needed to act as middleware between the output of the virtual processor 12 and the input of the field instrument 14a, as is well known in the art.

The virtual processor 12 may comprise both hardware and software, as is known in the art. The virtual processor 12 may comprise either or both of two types of simulation architectures. One type of architecture may be for low fidelity simulation applications, in which all simulation models are programmed into the virtual processor 12. A second type of system architecture is suitable for both low fidelity and high fidelity simulation applications and may require execution on a personal computer in order to provide sufficient memory. One processor usable as a virtual processor 12 is available from the Rockwell Automation Company of Milwaukee, Wis. under Model No. 1769-L32E.

Software for the virtual processor 12 converts the control signal 30a to a process signal 32a. Suitable software includes the IDEAS software, specifically, IDEAS OPC 2.0 software, available from IDEAS Simulation, Inc. of Decatur, Ga. and a subsidiary of Andritz AG and RS TestStand software available from Rockwell Automation of Milwaukee, Wis. to convert one or more control signals 30a, 30b, 30c, . . . , into one or more process signals 32a, 32b, 32c, . . . , within or for the virtual processor 12.

The virtual processor 12 may have one or more simulation models built in, as desired. Simulation model parameters may be changed automatically and/or manually in order to meet the requirements for simulating different process conditions. The commands are sent from the process controller 10 to the virtual processor 12 so that the virtual processor 12 may simulate process parameters, performance and functions, as desired. Such process parameters, performance and function are typically measured and monitored by the field instruments 14a, 14b, 14c, . . . , in the real world. Data gathered from the field instruments 14a, 14b, 14c, . . . , are used to make the simulation model, as is known in the art. The virtual processor 12 may be implemented through an algorithm which may be specific to the particular field instrument 14a or process under consideration. The virtual processor 12 can then provide an output which indicates a measurement of the parameter under consideration from that field instrument 14a. The output may be qualitative or preferably is quantitative. For example, if the field instrument 14a under consideration is a scale which receives batch flow, the algorithm could be used to generate a signal to the scale as a dynamic difference in weight. The change in weight per unit time may be thought of as the flow to be simulated. The field instruments 14a, 14b, 14c, . . . , may receive input from the virtual processor 12. Alternatively, the field instruments 16a, 16b, 16c, . . . , may only provide input to the process controllers.

When the system is in the simulation mode, the virtual processor 12 uses that model with the simulation parameters to generate simulation signals to be sent to the field instruments 14a, 14b, 14c, . . . , used with the present invention. Simulation algorithms may reside in the simulation logic used by the virtual processor 12. The purpose of the simulation logic is to generate output data through algorithms for simulating process signals 32a, 32b, 32c, . . . , to be sent to field instruments 14a, 14b, 14c, . . . . The simulation algorithm calculates a dynamic value for the process signal(s) based upon plant hardware and operating equipment, plant and physical constants, and other input. For example, a flow rate at a particular location may be easily calculated, as is known in the art, using differential pressure and the flow limiting component (such as pipe diameter or valve open position/flowthrough area). Likewise, dynamic weight change can be calculated knowing the tare weight and the dynamic rate of addition. A CompactLogix controller available from Rockwell Automation, or similar hardware, may be used to run the simulation algorithms.

Values of certain parameters for the algorithm may depend on the resolution of the output module used with the virtual processor 12. For example, using a Rockwell CompactLogix analog output module Model Number 1769-OF2, numeric data from 0 to 10000 created by the virtual processor 12 can generate corresponding signals of 0 to 10 volts DC, respectively. The generated output signals of 0 to 10 volts DC may then can be used to simulate a change in weight from a predetermined minimum to a predetermined maximum, calibrated in units such as kg, g, etc.

By way of non-limiting example, a flow rate may be simulated or calculated once per second, the flow rate F can be derived by Eq. (1).

$$F = \frac{{W}_{max} - {W}_{min}}{{O}_{max}} [ O ( t + 1 ) - O ( t ) ] \qquad ( 1 )$$

where
Oₘₐₓ is the maximum valid numeric data available from the analog output card per channel (for Rockwell 1769-OF2, Qₘₐₓ is 10000).
Wₘₐₓ is the maximum weight value from a calibrated scale (which may be greater than the calibrated scale capacity).
Wₘᵢₙ is the minimum weight value from a calibrated scale (which may be a negative number less than 0 weight).
O(t) are numeric data generated by the virtual processor 12 at its t-th scan time.
O(t+1) are numeric data generated by the virtual processor 12 at its (t+1)-th scan time.

Eq. (1) can be rearranged to make Eq.(2) if one considers that a calculation for new weight data is executed or scanned in the program routine N times per second.

$$dO = \frac{F * {O}_{max}}{{W}_{max} - {W}_{min}} N \qquad ( 2 )$$

where dO=O(t+1)-O(t) is an incremental numeric value relating a process signal to the flow rate F at a particular time. Therefore, new numeric data generated by the virtual processor 12 for a change in weight due to the flow rate F of material to the scale can be obtained with Eq. (3)
   O(t+1)=O(t)+dO. (3)

The output data from simulation logic may be generated by computation of an associated algorithm or model. Whether or not the output data are dynamically updated depends on the status of the command from the process controller 10. For example, to simulate a scale-based batch material transfer, a control signal 30a to open a valve triggers calculation of a process signal 32a which may be converted to a milli-volt signal by the converting circuit, if present, and then sent to the field instrument 14a. The milli-volt signal may simulate a load cell response to material transfer. The value of the output signal results from the parameter generated from the configuration logic. In another non-limiting example, a flowmeter-based material transfer may be used. Output signals from the virtual processor 12 may be provided in the form of pulse signals usable to simulate an output signal from a flow meter. Different frequencies of pulse signals may be configurable in both the static and dynamic modes, to represent different values of a particular flow parameter or other response within the system.

Configuration logic may also be used to obtain other simulation parameters in addition to the calibration data for the field instrument 14a. For example, simulation parameters obtained from the configuration logic may result from process signal information/data (e.g., flow rate, temperature, batch weight) and from the calibration data or calibration logic or system characterization, as may occur in the time domain or the frequency domain. Communication logic may be used to transfer such data between the process controller 10, virtual processor 12 and other system components such as an optional low or high fidelity simulation application.

The virtual processor 12 may perform a number of additional tasks. For example, calibration logic may be used to identify calibration data for the field instrument 14a. The calibration data may be used to understand static and/or dynamic characteristics of the field instrument 14a. Such calibration data may be used to describe a profile of the field instrument 14a, and to further serve as input parameters for a simulation algorithm.

The configuration may be set using a simulation mode or a non-simulation mode. If the configuration is set during a simulation mode, simulation parameters may be dynamically updated. If the configuration is set in non-simulation mode, a dynamic update of the simulation parameters may not be required. Typically, the calibration logic needs to be executed only once when the simulation is in the calibration mode in order to obtain calibration data for the instrument.

As noted above, the output from the virtual processor 12 is routable to one or more field instruments 14a, 14b, 14c, . . . , in the form of one or more simulation signals, typically one or more process signals 32a, 32b, 32c, . . . . As used herein, a field instrument 14a is a device which performs a function and may be utilized in actual operating conditions. According to the present invention, the at least one field instrument 14a may not necessarily be connected to a load, to a line or other device which performs the actual function. Instead, the function is simulated by the field instrument 14a. Field instruments 14a, 14b, 14c, . . . , may perform any function usable in an actual plant or other desired operation conditions, including but not limited to material transfer functions, operation of motors including servomotors, pressure vessel control, flow control, composition control, density, color, burner control, web handling, operation of knives and cutters, operation of vision systems, etc.

Additionally, the material transfer functions may include continuous transfer, batch transfer, instrumentation which provide indications of flow rate, flow on/flow off, weight, etc. Other field instruments 14a, 14b, 14c, . . . , may include motors, such as servomotors, may provide an indication of shaft position, optionally connected to a simulated load, RPM, torque, current, etc. Pressure vessel and burner control systems may be provided as field instruments 14a, 14b, 14c, . . . , with indications of pressure, temperature, presence of flame, etc. Web handling systems may be provided as field instruments 14a, 14b, 14c, . . . , with indications of web tension, lateral position of the web, idler roll position, roll diameter, torque, etc. Knives, cutters, printers, etc. may be provided as field instruments 14a, 14b, 14c, . . . , with indications of knife position, phase, print head or roll position, phase, etc. Vision systems may also be used as field instruments 14a, 14b, 14c, . . . . One illustrative field instrument is a comparator available from Mettler-Toledo of Columbus, Ohio sold under the designation of Q.i.

Physical measurements by the field instruments 14a, 14b, 14c, . . . , may include position, phase, temperature, angularity relative to the horizontal/vertical, distance, color, force, torque, etc. Chemical and biological measurements by the field instruments 14a, 14b, 14c, . . . , may include chemical composition, material content, age of bacteria, etc. If high fidelity simulation is desired, mathematic models for valve characteristics (opening and closing profiles), motor start and stop profiles, heat exchanger profiles of temperature change dynamics, etc. can be used to represent state changes, and the paths from one state, position, etc., to another.

If desired, one or more of the field instruments 14a, 14b, 14c, . . . , may have or recognize a setpoint. The setpoint may be predetermined. The field instrument 14a may receive the process signal 32a and determine its value relative to the setpoint. Any deviation from the setpoint may be determined to be an error, using simple subtraction, as is known in the art. The error may be a quantitative or analog signal indicating the value and/or sense (positive or negative) of the error. Alternatively, the error may be a discrete signal. A discrete error signal may indicate that a particular value has or has not been reached, without giving the magnitude of the deviation from the setpoint.

The field instrument 14a may be included as part of the device according to the present invention. Output from the field instrument 14a may be provided in the form of a process signal 32a. This process signal 32a may be sent to a read-out and optionally recorded. Additionally and/or alternatively, the output from the field instrument 14a may be routed back to the process controller 10 to provide a feedback loop. The status of the field instrument 14a may be obtained from the process controller 10 via a communication protocol (Ethernet or ControlNet, for example).

The field instrument 14a may have one or more input terminal(s). In an exemplary process control system, the input terminal(s) may be connected to the field devices such as load cells, flowmeters, etc. The required input of the field instrument 14a may be standard or non-standard electrical signal formats such as 0-5 V, 0-10 V, −10+10 V, 4-20 mA, etc., assuming an electrical simulation signal is selected.

If the optional process controller 10 and optional field instrument(s) are provided with the apparatus, the output from the process controller 10 may be routed as input to the virtual processor 12 in the form of one or more control signals 30a, 30b, 30c, . . . . Output from the virtual processor 12 may be routed as one or more process signals 32a, 32b, 32c, . . . , to the field instrument 14a. Optionally and alternatively, such output from the virtual processor 12 may be routed in the form of process signals 32a, 32b, 32c, . . . back to the process controller 10 to form a feedback loop.

As noted above, output from one or more of the field instruments 14a, 14b, 14c, . . . may be routed as feedback in the form of one or more process signals 32a, 32b, 32c, . . . , in a feedback loop to the process controller 10. Thus, the invention may comprise nested feedback loops wherein the feedback loop(s) from the virtual processor 12 to the process controller 10 is nested inside the feedback loop(s) from the field instrument 14a to the process controller 10. Of course, one of skill will recognize that either or both of these feedback loops may comprise single or plural process signals 32a, 32b, 32c, . . . , within that particular feedback loop. For example, the feedback loops may include a single input/single output, multiple input/single output, multiple input/multiple output and related control strategies, including but not limited to continuous, discrete and hybrid control strategies.

In yet another embodiment, the process signal 32a may be sent as output from the virtual processor 12 without receiving a control signal 30a from the process controller 10. Instead, the control signal 30a may be sent directly from the field instrument 14a to the virtual processor 12. This embodiment may be usable to test field instruments, 14a, 14b, 14c, . . . .

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for simulating responses to changes in a system, said apparatus comprising:
a process controller, said process controller being structured to receive one or more process signals and to convert said one or more process signals to one or more control signals;
said one or more control signals being communicated to a virtual processor as output from said process controller, said virtual processor being structured to receive said output from said process controller as input to said virtual processor, said input comprising at least one said control signal, said virtual processor converting said at least one control signal to at least one process signal, said virtual processor further being structured to send output, said output comprising said at least one process signal;
said output of said virtual processor being receivable by a field instrument as input thereto, whereby said field instrument may respond to said input received as said process signal.

2. An apparatus according to claim 1, further comprising a plurality of field instruments in communication with said virtual processor, each said field instrument of said plurality receiving at least one said process signal from said virtual processor as input to said field instrument, whereby each said field instrument may respond to a respective said process signal as input thereto and independently of other said field instruments.

3. An apparatus according to claim 2, wherein said virtual processor sends output therefrom to a plurality of field instruments and to said process controller.

4. An apparatus according to claim 2, wherein at least one said field instrument receives said input in the form of at least one said process signal and compares said input to a setpoint, and thereby determines the presence and/or magnitude of an error.

5. An apparatus according to claim 4, wherein said error is provided as output from said field instrument and routed in the form of a process signal as input to said process controller to thereby yield a first feedback loop.

6. An apparatus according to claim 5, wherein at least one process signal is provided as output from said virtual processor and routed back to said process controller as input thereto in the form of a process signal, to comprise a second feedback loop, said second feedback loop being nested within said first feedback loop.

7. An apparatus according to claim 2, wherein said field instrument provides a function selected from the group consisting of material transfer, web handling, servomotor operation, and vision system operation.

8. A device according to claim 7, wherein said field instrument provides a process signal indicating a value selected from the group consisting of flow rate, weight, RPM and pressure.

9. An apparatus according to claim 1, comprising a first plurality of control signals and a second plurality of process signals, wherein said second plurality is greater than said first plurality.

10. An apparatus according to claim 9, further comprising a converting circuit, said converting circuit being in communication with said virtual processor and said field instrument, whereby said converting circuit receives output from said virtual processor in the form of at least one process signal and converts said output to a form compatible as input to said field instrument.

11. A method for predicting responses in a system to changes occurring within said system, said method comprising the steps of:
providing a first output signal from an origin, said first output signal representing at least one control signal;
receiving said first output signal, and converting said at least one control signal to at least one process signal;
whereby said process signal represents at least one parameter within said system; and
providing said process signal as input to a field instrument, whereby said field instrument can respond to said input by starting, stopping or performing a predetermined function.

12. A method according to claim 11, further comprising the step of comparing said process signal received by said field instrument to a setpoint; and
determining the presence of an error based upon the difference between said process signal and said setpoint.

13. A method according to claim 12, further comprising the step of sending a status signal from said error determination in a first feedback loop to the origin of said first output signal.

14. A method according to claim 13, further comprising the step of sending at least one process signal to the origin of said control signal, in a second feedback loop, said second feedback loop being nested within said first feedback loop.

15. A method according to claim 13, further comprising the step of changing said first output signal from said origin based upon said feedback received from said first feedback loop, whereby said changes in said control signal represent changes in a system being simulated.

16. A method according to claim 14, further comprising the step of changing said first output signal from said origin based upon said feedback received from said second feedback loop, whereby said changes in said control signal represent changes in a system being simulated.

17. An apparatus for simulating changes in a system, said apparatus comprising:
a virtual processor, said virtual processor being structured to convert at least one control signal to at least one process signal, said virtual processor further being structured to send output comprising said at least one process signal to a field instrument as input thereto, whereby said field instrument may respond to said input received as said process signal.

18. An apparatus according to claim 17 wherein said field instrument provides a response indicating the qualitative or quantitative status of said field instrument.
